(19) United States
(12) Patent Application Publication
(10) Pub. No.: US 2004/0156129 A1
(43) Pub. Date: Aug. 12, 2004

(54) Safety rearview mirror

(76) Inventor: Elvis O. Diaz, Orlando, FL (US)

Correspondence Address: EDWARD M. LIVINGSTON, PA, 963 TRAIL TERRACE DRIVE, NAPLES, FL, 34103, US

(21) Appl. No.: 10/364,885

(22) Filed: Feb. 11, 2003

(51) Int. Cl. G02B 5/08; G02B 7/18; G02B 7/182

(52) U.S. Cl. 359/843; 359/846

(57) ABSTRACT

A safety rearview mirror has flexible mirrors (1) that are flexed selectively with a flex-control switch (2) on a turn-signal lever (4) of a motor vehicle (6). The flex-control switch controls a flex actuator (7) that is in contact with a back side of the flexible mirror. The flexible mirror is flexed to a convexly flexed mode to provide wide-area rearview for eliminating rearview blind spots, for lane-changing, for turning, for backing up and for responding to rearward conditions and dangers. For non-widened rearview, the flexible mirror is flexed to a flat mode. The flex-control switch is adapted to be affixed to the turn-signal lever for actuating the flexed mode by turn-signaling with the turn-signal lever. Return steering after a turn or de-activating the turn signal deactivates the flexed mode. Optionally also, the flex-control switch includes a non-signaling flex-control switch (3) that can be adapted for actuating and de-actuating the flexed mode by hand operation without turn-signal movement of the turn-signal lever. The flexible mirror includes a vehicle-compatible rearview-mirror case (10) that is affixable to either or both sides and inside of a motor vehicle predeterminedly. Communication of flex control from the flex-control switch to the flex actuator wherever the flexible mirror is positioned can be mechanical, electrical, radio-wave, computer-controlled or combinations thereof predeterminedly.

### BACKGROUND OF THE INVENTION

This invention relates to vehicle mirrors that are flexible between flatness for straight rear viewing and convexness for wide-angle viewing to avoid blind spots for turning, lane changing, backing up and responding to aft conditions.

Convexness of mirrors for wide-angle viewing is well-known. There are a plurality of known rearview mirrors for motor vehicles that employ this principle. Most notably are large, commercial-use rearview mirrors having a straight-mirror portion and a convex-mirror portion for wide-angle viewing on trucks, busses and other large vehicles. For cars, large mirrors are avoided for appearance preferences and also for avoiding wind resistance in proportion to total power and smaller size of cars.

Due to the preference for small rearview mirrors for cars, some adjustable-surface rearview mirrors have been devised. None, however, have sufficiently fail-safe reliability and convenience of use while driving to have become commercially successful and publicly demanded. The purpose of this invention, therefore, is to fill a need gap of reliability and safety for rearview mirrors with surface adjustment between flatness for straight driving and convexness for turning, lane changing and rear-factor assessment.

Examples of most-closely related known but different surface-adjustment mirrors are described in the following patent documents:

| Patent No. | | |
|---|---|---|
| (U.S. unless | | |
| stated otherwise) | Inventor | Issue Date |
| 2002/0,015,243 | Glovatsky, et al. | Feb. 7, 2002 |
| 6,317,229 | Otterson | Nov. 13, 2001 |
| 4,561,732 | Japes | Dec. 31, 1985 |
| GB 2,195,593 | Ufrecht | Apr. 13, 1988 |
| DE 3828221 | | Aug. 19, 1988 |
| 4,128,310 | Miller | Feb. 5, 1978 |
| 3,610,738 | Bochmann | 0-5-1971 |
| 5,608,581 | Potman | Mar. 4, 1997 |

### SUMMARY OF THE INVENTION

Objects of patentable novelty and utility taught by this invention are to provide a safety rearview mirror which:

adjusts a rearview mirror automatically from a flat straight-view mode to a convex wide-view mode by turn-signaling with a turn-signal lever on a motor vehicle;

readjusts automatically to the flat straight-view mode by automatic steering termination of turn-signaling;

optionally adjusts to the convex wide-view mode or to the flat straight-view mode by a predetermined mode-change touching or other handling of a switch element on the turn-signal lever for wide rear-viewing in contemplation of turning or other driving maneuver without turn-signaling with the turn-signal lever;

optionally remains in either the straight or the convex mode until the predetermined mode-change touching or other handling of the switch element is repeated or reversed;

has adjustable level of convexness of the wide-view mode;

includes computer-control changing of modes; and

can be adapted for original-equipment manufacture or for after-market installation.

This invention accomplishes these and other objects with a safety rearview mirror having a flexible mirror that is flexed selectively with a flex-control switch on a turn-signal lever of a motor vehicle. The flex-control switch controls a flex actuator that is in contact with a back side of the flexible mirror. The flexible mirror is flexed to a convexly flexed mode to provide wide-area rearview for eliminating rearview blind spots, for lane-changing, for turning, for backing up and responding to rearward conditions and dangers. For straight-ahead driving, the flexible mirror is flexed to a flat mode. The flex-control switch is adapted to be affixed to the turn-signal lever for actuating the convexly flexed mode by turn-signaling with the turn-signal lever. Return steering after a turn or de-activating the turn signal deactivates the convexly flexed mode. Optionally also, the flex-control switch can be adapted for actuating and de-actuating the convexly flexed mode by hand operation without turn-signal movement of the turn-signal lever. The flexible mirror is housed in a vehicle-compatible rearview-mirror case that is affixable to either or both sides and proximate a windshield of a motor vehicle predeterminedly. Communication of flex control from the flex-control switch to the flex actuator wherever the flexible mirror is positioned can be mechanical, electrical, radio-wave, computer-controlled or combinations thereof predeterminedly.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a schematic representation of a motor vehicle having rectangular flexible rearview mirrors that are flexed to a flat mode with a turn-signal lever in a non-signaling orientation and having a non-signaling flex-control switch oriented for signaling the flat mode;

FIG. 2 is a schematic representation of the motor vehicle having the rectangular flexible rearview mirrors flexed to a convexly flexed mode with the turn-signal lever in a signaling orientation and having the non-signaling flex-control switch oriented for actuating the flat mode;

FIG. 3 is a schematic representation of the motor vehicle having the rectangular flexible rearview mirrors flexed to the convexly flexed mode with the turn-signal lever in the non-signaling orientation and having the non-signaling flex-control switch oriented for signaling the convexly flexed mode;

FIG. 4 is a partially cutaway side view of a circular flexible rearview mirror actuated to the flat mode with a flex actuator;

FIG. 5 is a partially cutaway side view of the circular flexible rearview mirror actuated to the convexly flexed mode with a flex actuator;

FIG. 6 is a schematic representation of the motor vehicle having two side circular and one inside rectangular flexible rearview mirrors flexed to the convexly flexed mode with the turn-signal lever in the non-signaling orientation and having the non-signaling flex-control switch oriented for signaling the convexly flexed mode;

FIG. 7 is a schematic representation of the motor vehicle having the two side circular and one inside rectangular flexible rearview mirrors flexed to the flat mode with the turn-signal lever in the non-signaling orientation and having the non-signaling flex-control switch oriented for signaling the flat mode;

FIG. 8 is a partially cutaway top view of the rectangular flexible rearview mirror actuated to the flat mode with the flex actuator;

FIG. 9 is a partially cutaway top view of the rectangular flexible rearview mirror actuated to the convexly flexed mode with the flex actuator; and

FIG. 10 is a partially cutaway side view of the rectangular flexible rearview mirror actuated to the convexly flexed mode with the flex actuator

### DESCRIPTION OF PREFERRED EMBODIMENT

Listed numerically below with reference to the drawings are terms used to describe features of this invention. These terms and numbers assigned to them designate the same features throughout this description.

| | |
|---|---|
| 1. | Flexible mirror |
| 2. | Signaling flex-control switch |
| 3. | Non-signaling flex-control switch |
| 4. | Turn-signal lever |
| 5. | Steering wheel |
| 6. | Motor vehicle |
| 7. | Flex actuator |
| 8. | Rectangular mirror |
| 9. | Circular mirror |
| 10. | Rearview-mirror case |
| 11. | Mounts |
| 12. | Transmitter |
| 13. | Transmission line |
| 14. | Signaling line |
| 15. | Non-signaling line |
| 16. | Current line |
| 17. | Movable member |
| 18. | Linear-contact portion |
| 19. | Inside rearview mirror |

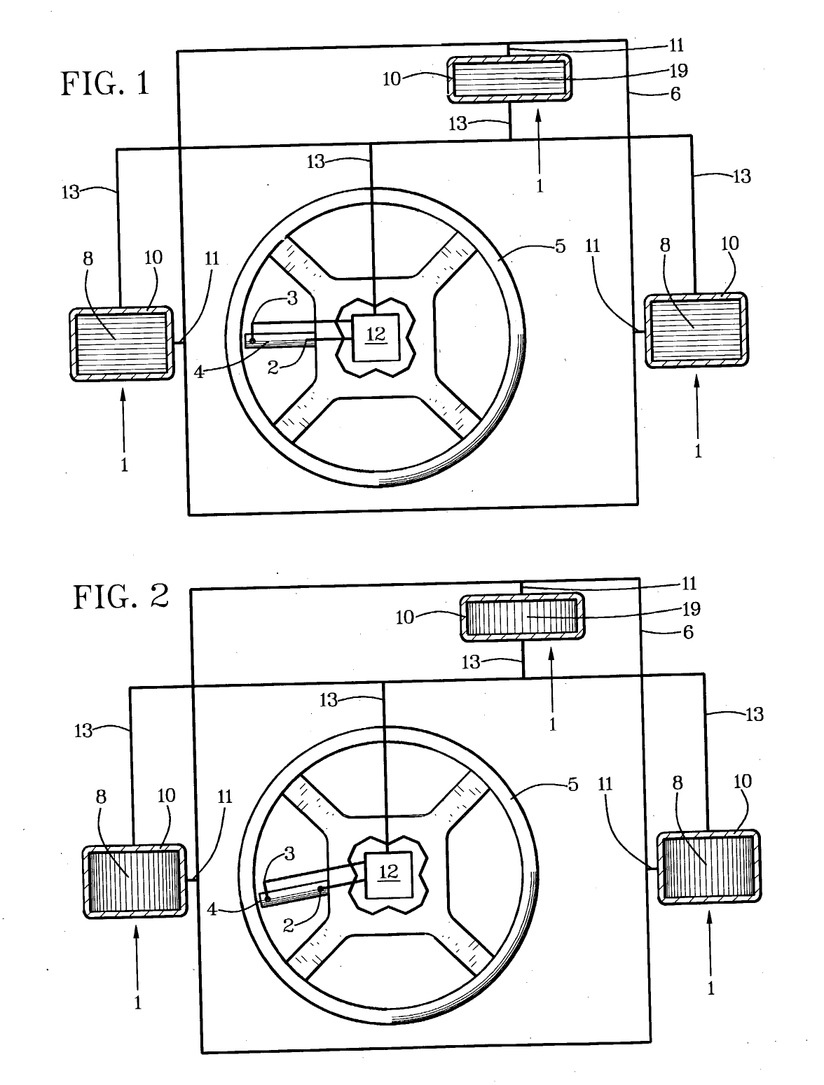

Referring to FIGS. 1-3 and 6-7, the safety rearview mirror has at least one flexible mirror 1 that is flexed selectively with at least one flex-control switch, which can include a signaling flex-control switch 2 and a non-signaling flex-control switch 3 on a turn-signal lever 4 that is proximate a steering wheel 5 of a motor vehicle 6.

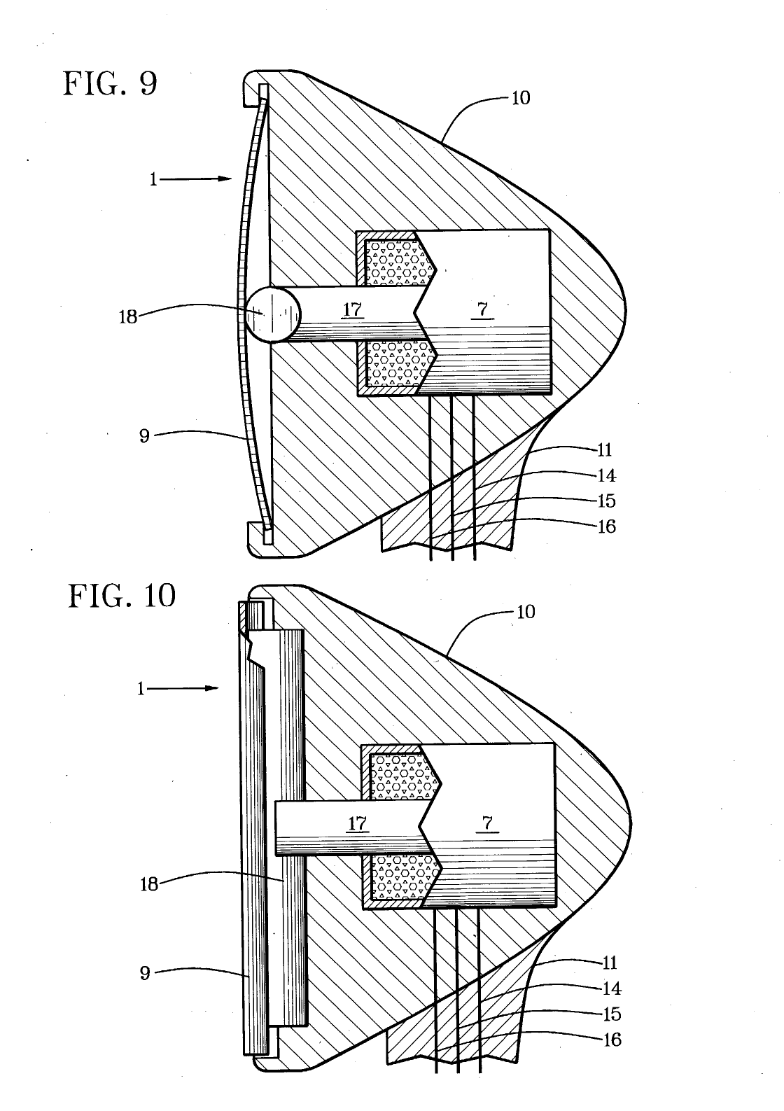

Referring to FIGS. 1-10, a flex actuator 7 is in predetermined contact with a back side of the flexible mirror 1 for controlling flex of the flexible mirror 1 with the signaling flex-control switch 2 and optionally with the non-signaling flex-control switch 3.

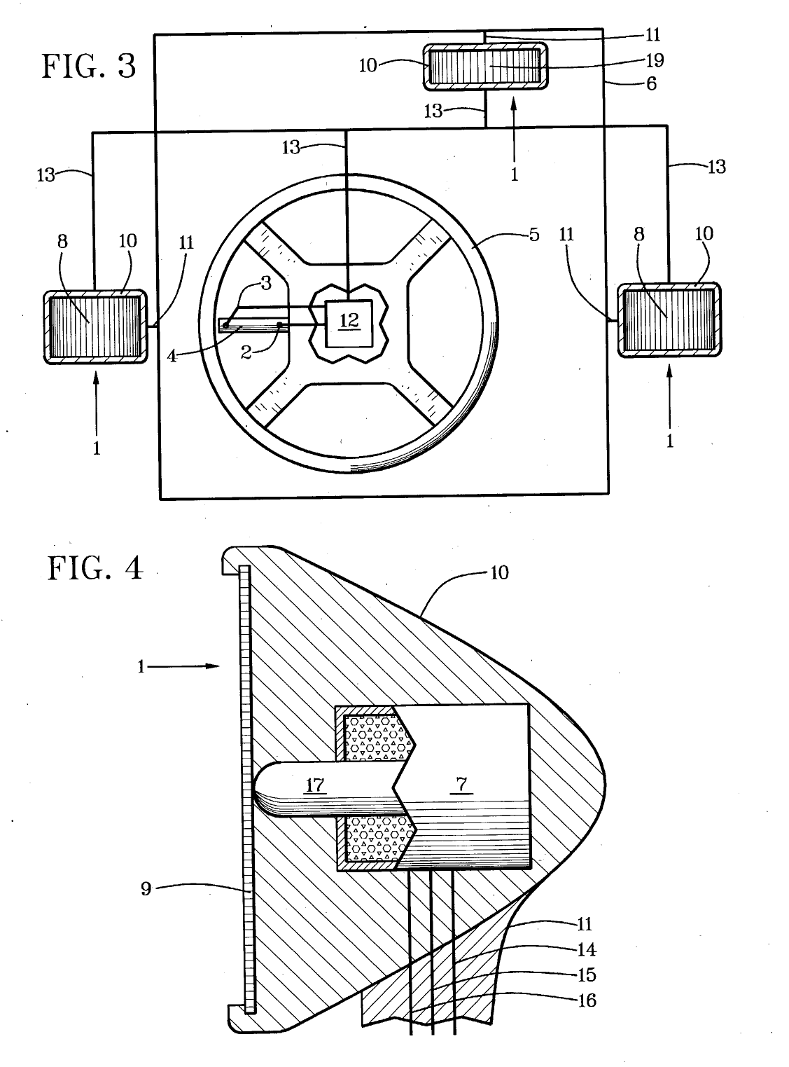

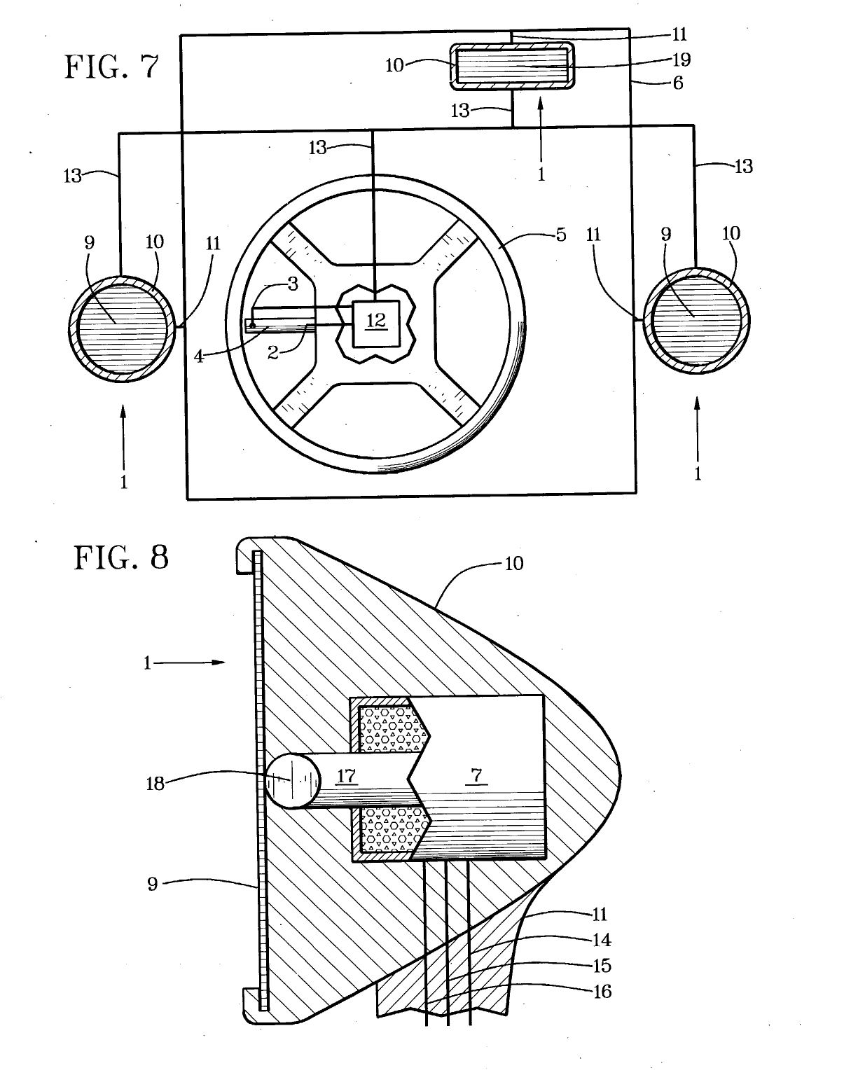

The flexible mirror 1 is adapted for being flexed to a convexly flexed mode by turn-signaling with the turn-signal lever 4. The convexly flexed mode of the rearview mirror 1, as represented by progressively separated vertical shade lines for rectangular mirrors 8 in FIGS. 2-3 and by progressively separated circular shade lines for circular mirrors 9 in FIG. 6, is adapted to provide wide-area rearview for eliminating rearview blind spots, for lane-changing, for turning, for backing up and for responding to rearward conditions and dangers selectively. The flexible mirror 1 is adapted for being flexed to a flat mode, as represented by horizontal shade lines on the flexible mirror 1 shown in FIGS. 1 and 7, for non-widened rearview by return steering of the motor vehicle 6 after a turn, by deactivating the turn-signaling with the turn-signal lever 4 or optionally by restoring the flat mode with the non-signaling flex-control switch 3.

The flexible mirror 1 includes a vehicle-compatible rearview-mirror case 10, whether rectangular or circular, that is adapted to be affixed to the motor vehicle 6 predeterminedly as represented with mounts 11 shown schematically as lines in FIGS. 1-3 and 6-7 and as shown on the rearview-mirror case 10 in FIGS. 4-5 and 8-10.

The flex-control switch, which includes the signaling flex-control switch 2 and the optional non-signaling flex-control switch 3, is in flex control of the flex actuator 7 predeterminedly through a transmitter 12 proximate the steering wheel 5. Transmission by the transmitter 12 can be by electrical lines or otherwise. A transmission line 13 for transmitting all control communication from the transmitter 12 is shown as a line extending from the transmitter 12 and branching to the flexible mirrors 1 in FIGS. 1-3 and 6-7. At the mounts 11 and extending to the flex actuator 7 depicted in FIGS. 4-5 and 8-10, transmission of control communication is shown separately as a signaling line 14 in communication from the signaling flex-control switch 2 and as a non-signaling line 15 in communication from the non-signaling flex-control switch 3. In addition, current line 16 is shown for conveying current to the flex actuator 7 independently from a vehicle-electric system or elsewhere.

As illustrated in FIGS. 4-5 and 8-10, the flex actuator 7 includes an electrical solenoid on the rearview-mirror case 10. An electrical solenoid is intended to include a linear or a rotational motor that actuates a two-way movable member 17 that is attached to proximate a central portion of the back side of the flexible mirror 1 for pushing the central portion of the flexible mirror 1 outwardly in relationship to the rearview-mirror case 10 for the convexly flexed mode and for pulling the central portion of the flexible mirror 1 inwardly for the flat mode selectively. The movable member 17 can include machine threads for being rotated with a rotary solenoid or a mechanical linkage can be provided intermediate either a rotary or a linear motor as the actuator 7 for actuating the movable member 17.

As illustrated in FIGS. 1-10, the flex-control switch includes the signal flex-control switch 2 with a control circuit for actuation-control communication to the flex actuator 7 by turn-signaling with the turn-signal lever 4. The actuation-control communication includes communication to actuate the flex actuator 7 to the convexly flexed mode by signaling a turn with the turn-signal lever 4 and to actuate the flex actuator 7 to the flat mode by return steering of the motor vehicle 6 with the steering wheel 5 or by de-activating the signaling of the turn with the turn-signal lever 4. In FIG. 1, the turn-signal lever 4 is horizontal in a non-signaling mode, all flexible mirrors 1 are in the flat mode and the non-signaling flex-control switch 3 is in a non-activated mode. In FIG. 2, the turn-signal lever 4 is below horizontal to signal a left turn, but could be above horizontal to signal a right turn, and the flexible mirrors 1 are in the convexly flexed mode.

The flex-control switch includes the non-signaling flex-control switch 3 with a control circuit for actuation-control communication to the flex actuator 7 with predetermined actuation of the flex-control switch. The actuation-control communication to the flex actuator 7 by the predetermined actuation of the non-signaling flex-control switch 3 includes actuation of the flex actuator 7 to the convexly flexed mode and to the flat mode selectively. In FIGS. 3 and 6, the turn-signal lever 4 is horizontal for non-actuation of the signal flex-control switch 2, but the non-signaling flex-control switch 3 is activated as illustrated by a slanted orientation and the flexible mirrors 1 are in the convexly flexed mode.

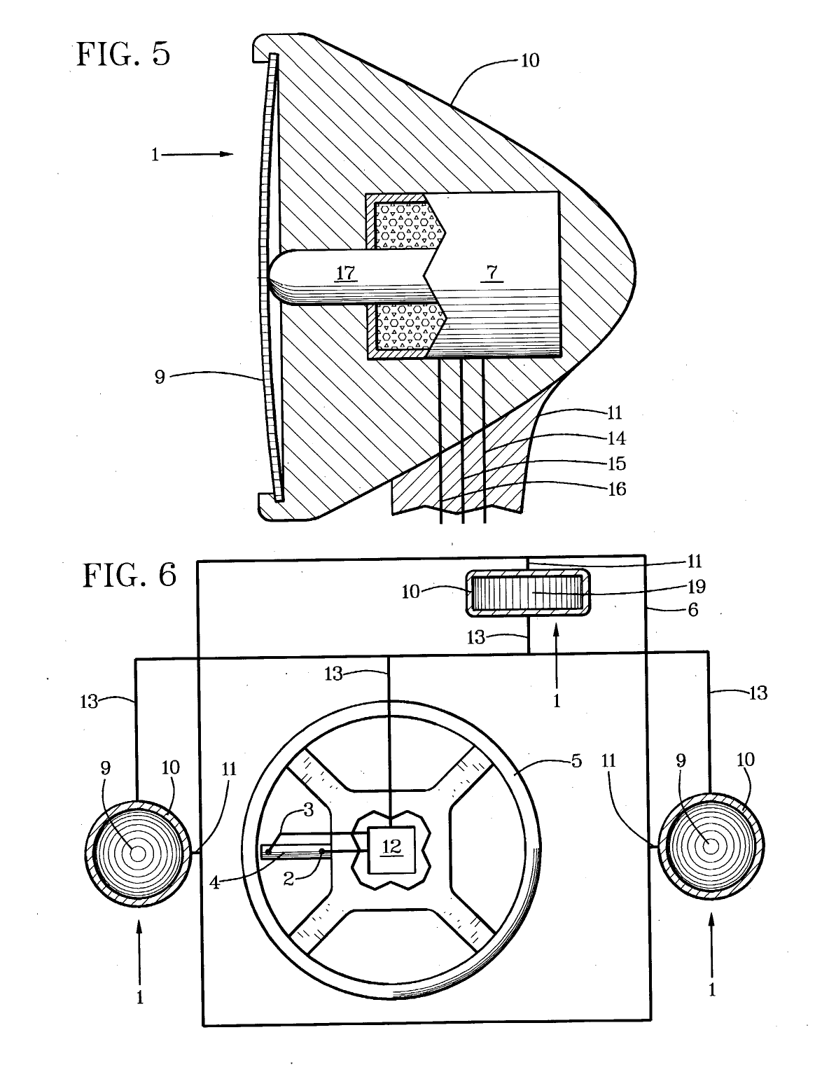

As illustrated in FIGS. 4-7, the flexible mirror 1 includes the circular mirror 9. As shown further in FIGS. 4-5, the movable member 17 of predetermined forms of the electrical solenoid includes a point-contact portion in point contact with the back side of the flexible mirror 1. In FIGS. 4 and 7 the circular mirror 9 is in the flat mode. In FIGS. 5 and 6, the circular mirror 9 is in the convexly flexed mode from having been pushed outwardly by point contact with the movable member 17.

As illustrated in FIGS. 1-3 and 8-10, the flexible mirror 1 includes the rectangular mirror 8. As shown further in FIGS. 8-10, the movable member 17 of predetermined forms of the electrical solenoid includes a linear-contact portion 18 in linear contact with the back side of the flexible mirror 1. In FIGS. 1 and 8 the rectangular mirror 8 is in the flat mode. In FIGS. 2-3 and 9-10, the rectangular mirror 8 is in the convexly flexed mode from having been pushed outwardly by linear contact with the linear-contact portion 18 of the movable member 17. The movable member 17 of the electrical solenoid includes the linear-contact portion 18 that is in linear contact with the back side of the flexible mirror 1.

As depicted in FIGS. 1-3 and 6-7, the flexible mirror 1 includes two side rearview mirrors which can be the rectangular mirror 8, the circular mirror 9 or other form of side rearview mirror. Additionally, the flexible mirror 1 can include an inside rearview mirror 19 that is substantially the same as the rectangular mirror 8 with different dimensions.

A new and useful safety rearview mirror having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A safety rearview mirror comprising:
at least one flexible mirror that is flexed selectively with at least one flex-control switch on a turn-signal lever of a motor vehicle;
a flex actuator that is in predetermined contact with a back side of the flexible mirror for controlling flex of the flexible mirror with the flex-control switch;
the flexible mirror being adapted for being flexed to a convexly flexed mode by turn-signaling with the turn-signal lever and by placing a gear shift lever to a reverse position, selectively;
the convexly flexed mode of the rearview mirror being adapted to provide wide-area rearview for eliminating rearview blind spots, for lane-changing, for turning, for backing up and for responding to rearward conditions and dangers selectively;
the flexible mirror being adapted for being flexed to a flat mode for non-widened rearview by return steering of the motor vehicle after a turn, by deactivating the turn-signaling and by placing the gear shift lever from the reverse position, selectively;
the flexible mirror including a vehicle-compatible rearview-mirror case that is adapted to be affixed to the motor vehicle predeterminedly; and
the flex-control switch being in flex control of the flex actuator predeterminedly.

2. The safety rearview mirror of claim 1 wherein:
the flex actuator includes an electrical solenoid on the rearview-mirror case; and
the electrical solenoid includes a two-way movable member that is attached to proximate a central portion of the back side of the flexible mirror for pushing the central portion of the flexible mirror outwardly in relationship to the rearview-mirror case for the convexly flexed mode and for pulling the central portion of the flexible mirror inwardly for the flat mode selectively.

3. The safety rearview mirror of claim 2 wherein:
the flex-control switch includes a signaling flex-control switch with control circuit for actuation-control communication to the flex actuator by turn-signaling with the turn-signal lever.

4. The safety rearview mirror of claim 3 wherein:
the actuation-control communication includes communication to actuate the flex actuator to the convexly flexed mode by signaling a turn with the turn-signal lever and to actuate the flex actuator to the flat mode by return steering of the motor vehicle or by de-activating the signaling of the turn with the turn-signal lever.

5. The safety rearview mirror of claim 2 wherein:
the flexible mirror includes a round mirror; and
the movable member of the electrical solenoid includes a point-contact portion in point contact with the back side of the flexible mirror.

6. The safety rearview mirror of claim 2 wherein:
the flexible mirror includes a rectangular mirror; and
the movable member of the electrical solenoid includes a linear-contact portion in linear contact with the back side of the flexible mirror.

7. The safety rearview mirror of claim 1 wherein:
the flex-control switch includes a non-signaling flex-control switch with a control circuit for actuation-control communication to the flex actuator with predetermined actuation of the flex-control switch.

8. The safety rearview mirror of claim 7 wherein:
the actuation-control communication to the flex actuator by the predetermined actuation of the non-signaling flex-control switch includes actuation of the flex actuator to the convexly flexed mode and to the flat mode selectively.

9. The safety rearview mirror of claim 1 wherein:
the flexible mirror includes two side rearview mirrors.

10. The safety rearview mirror of claim 9 wherein:
the flexible mirror includes an inside rearview mirror.

11. The safety rearview mirror of claim 1 wherein:
the flexible mirror includes an inside rearview mirror.

12. A safety rearview mirror comprising:
at least one flexible mirror that is flexed selectively with at least one flex-control switch on a turn-signal lever of a motor vehicle;
a flex actuator that is attached predeterminedly to a back side of the flexible mirror for actuating flex of the flexible mirror with the flex-control switch;
the flexible mirror being adapted for being flexed to a convexly flexed mode to provide wide-area rearview for eliminating rearview blind spots, for lane-changing, for turning, for backing up and for responding to rearward conditions and dangers selectively;
the flexible mirror being adapted for being flexed to a flat mode for non-widened rearview;
the flex-control switch includes the non-signaling flex-control switch that is adapted to include actuation-control communication to the flex actuator with predetermined actuation of the non-signaling flex-control switch independently of communication of turn-signaling with the turn-signal lever;
the actuation-control communication to the flex actuator with the predetermined actuation of the non-signaling flex-control switch includes communication to actuate the flex actuator for the convexly flexed mode and to actuate the flex actuator for the flat mode selectively;
the flexible mirror including a vehicle-compatible rearview-mirror case that is adapted to be affixed to the motor vehicle predeterminedly; and
the flex-control switch being in flex-control communication with the flex actuator predeterminedly.

13. The safety rearview mirror of claim 12 wherein:
the non-signaling flex-control switch includes a switch member on the turn-signal lever of the motor vehicle.

14. The safety rearview mirror of claim 13 wherein:
the switch member includes a control circuit for control communication from the switch member to the flex actuator.

15. The safety rearview mirror of claim 12 wherein:
the flex actuator includes an electrical solenoid on the rearview-mirror case; and
the electrical solenoid includes a two-way movable member that is attached to proximate a central portion of the back side of the flexible mirror for pushing the central portion of the flexible mirror outwardly in relationship to the rearview-mirror case for the convexly flexed mode and for pulling the central portion of the flexible mirror inwardly for the flat mode selectively.

16. The safety rearview mirror of claim 15 wherein:
the flex-control switch includes a control circuit for actuation-control communication to the flex actuator by turn-signaling with the turn-signal lever.

17. The safety rearview mirror of claim 15 wherein:
the flexible mirror includes a round mirror; and
the movable member of the electrical solenoid includes a point-contact portion in point contact with the back side of the flexible mirror.

18. The safety rearview mirror of claim 15 wherein:
the flexible mirror includes a rectangular mirror; and
the movable member of the electrical solenoid includes a linear-contact portion in linear contact with the back side of the flexible mirror.

19. The safety rearview mirror of claim 12 wherein:
the flexible mirror includes two side rearview mirrors.

20. The safety rearview mirror of claim 1 wherein:
the flexible mirror includes an inside rearview mirror.

21. The safety rearview mirror of claim 12 wherein:
the flexible mirror includes an inside rearview mirror.
